(19) United States
(12) Patent Application Publication
(10) Pub. No.: US 2015/0237610 A1
(43) Pub. Date: Aug. 20, 2015

(54) NEIGHBOR CELL ASSISTED TDD CONFIGURATION

(71) Applicants: Yuantao ZHANG, Beijing (CN); Haipeng LEI, Beijing (CN); Jianchi ZHU, Beijing (CN); Zhi ZHANG, Daxing District, Beijing (CN); Kodo SHU, Beijing (CN); NOKIA CORPORATION, Espoo (FI)

(72) Inventors: Yuantao Zhang, Beijing (CN); Haipeng Lei, Beijing (CN); Jianchi Zhu, Beijing (CN); Zhi Zhang, Beijing (CN); Kodo Shu, Shanghai (CN)

(21) Appl. No.: 14/433,768

(22) PCT Filed: Nov. 6, 2012
(86) PCT No.: PCT/CN2012/084141

§ 371 Date: Apr. 6, 2015

(51) Int. Cl. H04W 72/04; H04L 5/00; H04L 1/18; H04L 5/14

(52) U.S. Cl. CPC H04W 72/0406; H04L 5/1469; H04W 72/0446; H04L 5/0055; H04L 1/1812

(57) ABSTRACT

A method for neighbor cell assisted TDD configurations is described. The method includes receiving, from a serving cell, a first configuration. The first configuration is a cell specific configuration which indicates a first set of individual configurations for each of a plurality of SFs. A second configuration is received from the serving cell. The second configuration is a UE specific configuration which indicates a second set of individual configurations for each of the plurality of SFs. The method includes determining whether a given SF is configured differently in the first configuration than in the second configuration. In response to determining that the given SF is configured differently in the first configuration than in the second configuration, the method also includes communicating, with a neighbor cell, in the given SF as configured in the second configuration. Apparatus and computer readable media are also described.

### TECHNICAL FIELD

The exemplary and non-limiting embodiments relate generally to wireless communication systems, methods, devices and computer programs and, more specifically, relate to neighbor cell assisted TDD configurations.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

3GPP LTE/LTE-Advanced LTE systems, such as LTE-based enhanced local area (eLA) networks, may be deployed for small cells. The techniques provided by Rel.12 target cells both with and without macro coverage, both outdoor and indoor deployments and both ideal and non-ideal backhaul between eLA eNBs and between eLA eNB/Macro eNB. Both sparse and dense small cell deployments would also be enabled.

Higher frequency bands, such as the 3.5 GHz band for example, may be applied for small cells, under which a time domain duplex (TDD) mode may be configured. The traffic in small cells is expected to fluctuate greatly due to the number of users per small cell being typically small which is due in part to the small coverage area. Additionally, the user distribution is also expected to fluctuate greatly between the individual cells.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method for neighbor cell assisted TDD configurations. The method includes receiving, from a serving cell, a first configuration. The first configuration is a cell specific configuration which indicates a first set of individual configurations for each of a plurality of SFs. The method includes receiving, from the serving cell, a second configuration. The second configuration is a UE specific configuration which indicates a second set of individual configurations for each of the plurality of SFs. The method includes determining whether a given SF is configured differently in the first configuration than in the second configuration. In response to determining that the given SF is configured differently in the first configuration than in the second configuration, the method also includes communicating, with a neighbor cell, in the given SF as configured in the second configuration.

In a further aspect thereof an exemplary embodiment provides a method for neighbor cell assisted TDD configurations. The method includes communicating, by a serving cell, configuration information with a neighbor cell. The method includes determining a first configuration. The first configuration is a cell specific configuration which indicates a first set of individual configurations for each of a plurality of SFs. The method includes determining a second configuration based on the configuration information and the first configuration. The second configuration is a UE specific configuration which indicates a second set of individual configurations for each of the plurality of SFs. The method includes sending the first configuration to the UE and sending the second configuration to the UE. The method also includes during a given SF which is configured differently in the first configuration than in the second configuration, preventing communication between the serving cell and the UE.

In another aspect thereof an exemplary embodiment provides an apparatus for neighbor cell assisted TDD configurations. The apparatus comprises at least one processor and at least one memory storing computer program code. The at least one memory and the computer program code are configured to, with the at least one processor, cause the apparatus to perform actions. The actions include to receive, from a serving cell, a first configuration. The first configuration is a cell specific configuration which indicates a first set of individual configurations for each of a plurality of SFs. The actions include to receive, from the serving cell, a second configuration. The second configuration is a UE specific configuration which indicates a second set of individual configurations for each of the plurality of SFs. The actions include to determine whether a given SF is configured differently in the first configuration than in the second configuration. In response to determining that the given SF is configured differently in the first configuration than in the second configuration, the actions also include to communicate, with a neighbor cell, in the given SF as configured in the second configuration.

In a further aspect thereof an exemplary embodiment provides an apparatus for neighbor cell assisted TDD configurations. The apparatus comprises at least one processor and at least one memory storing computer program code. The at least one memory and the computer program code are configured to, with the at least one processor, cause the apparatus to perform actions. The actions include to communicate, by a serving cell, configuration information with a neighbor cell. The actions include to determine a first configuration. The first configuration is a cell specific configuration which indicates a first set of individual configurations for each of a plurality of SFs. The actions include to determine a second configuration based on the configuration information and the first configuration. The second configuration is a UE specific configuration which indicates a second set of individual configurations for each of the plurality of SFs. The actions include to send the first configuration to the UE and to send the second configuration to the UE. During a given SF which is configured differently in the first configuration than in the second configuration, the actions also include to prevent communication between the serving cell and the UE.

In another aspect thereof an exemplary embodiment provides a computer readable medium for neighbor cell assisted TDD configurations. The computer readable medium is tangibly encoded with a computer program executable by a processor to perform actions. The actions include receiving, from a serving cell, a first configuration. The first configuration is a cell specific configuration which indicates a first set of individual configurations for each of a plurality of SFs. The actions include receiving, from the serving cell, a second configuration. The second configuration is a UE specific configuration which indicates a second set of individual configurations for each of the plurality of SFs. The actions include determining whether a given SF is configured differently in the first configuration than in the second configuration. In response to determining that the given SF is configured differently in the first configuration than in the second configuration, the actions also include communicating, with a neighbor cell, in the given SF as configured in the second configuration.

In a further aspect thereof an exemplary embodiment provides a computer readable medium for neighbor cell assisted TDD configurations. The actions include communicating, by a serving cell, configuration information with a neighbor cell. The actions include determining a first configuration. The first configuration is a cell specific configuration which indicates a first set of individual configurations for each of a plurality of SFs. The actions include determining a second configuration based on the configuration information and the first configuration. The second configuration is a UE specific configuration which indicates a second set of individual configurations for each of the plurality of SFs. The actions include sending the first configuration to the UE and sending the second configuration to the UE. The actions also include during a given SF which is configured differently in the first configuration than in the second configuration, preventing communication between the serving cell and the UE.

In another aspect thereof an exemplary embodiment provides an apparatus for neighbor cell assisted TDD configurations. The apparatus includes means for receiving, from a serving cell, a first configuration. The first configuration is a cell specific configuration which indicates a first set of individual configurations for each of a plurality of SFs. The apparatus includes means for receiving, from the serving cell, a second configuration. The second configuration is a UE specific configuration which indicates a second set of individual configurations for each of the plurality of SFs. The apparatus includes means for determining whether a given SF is configured differently in the first configuration than in the second configuration. The apparatus also includes means for communicating, with a neighbor cell, in the given SF as configured in the second configuration in response to determining that the given SF is configured differently in the first configuration than in the second configuration.

In a further aspect thereof an exemplary embodiment provides an apparatus for neighbor cell assisted TDD configurations. The apparatus includes means for communicating configuration information with a neighbor cell. The apparatus includes means for determining a first configuration. The first configuration is a cell specific configuration which indicates a first set of individual configurations for each of a plurality of SFs. The apparatus includes means for determining a second configuration based on the configuration information and the first configuration. The second configuration is a UE specific configuration which indicates a second set of individual configurations for each of the plurality of SFs. The apparatus includes means for sending the first configuration to the UE and means for sending the second configuration to the UE. The apparatus also includes means for preventing communication between the serving cell and the UE during a given SF which is configured differently in the first configuration than in the second configuration.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 illustrates an exemplary small cell deployment suitable for use in practicing various exemplary embodiments.

FIG. 2 is a logic flow diagram that illustrates the operation of an exemplary method, and a result of execution of computer program instructions embodied on a computer readable memory, in accordance with various exemplary embodiments.

FIG. 3 shows exemplary configurations for use in accordance with various exemplary embodiments.

FIG. 4 shows a first set of configurations for use by exemplary electronic devices when practicing various exemplary embodiments.

FIG. 5 demonstrates a signaling diagram in accordance with the first set of configurations as shown in FIG. 4.

FIG. 6 shows another set of configurations for use by exemplary electronic devices when practicing various exemplary embodiments.

FIG. 7 shows a further set of configurations for use by exemplary electronic devices when practicing various exemplary embodiments.

FIG. 8 shows a simplified block diagram of exemplary electronic devices that are suitable for use in practicing various exemplary embodiments.

FIG. 9 is a logic flow diagram that illustrates the operation of another exemplary method, and a result of execution of computer program instructions embodied on a computer readable memory, in accordance with various exemplary embodiments.

### DETAILED DESCRIPTION

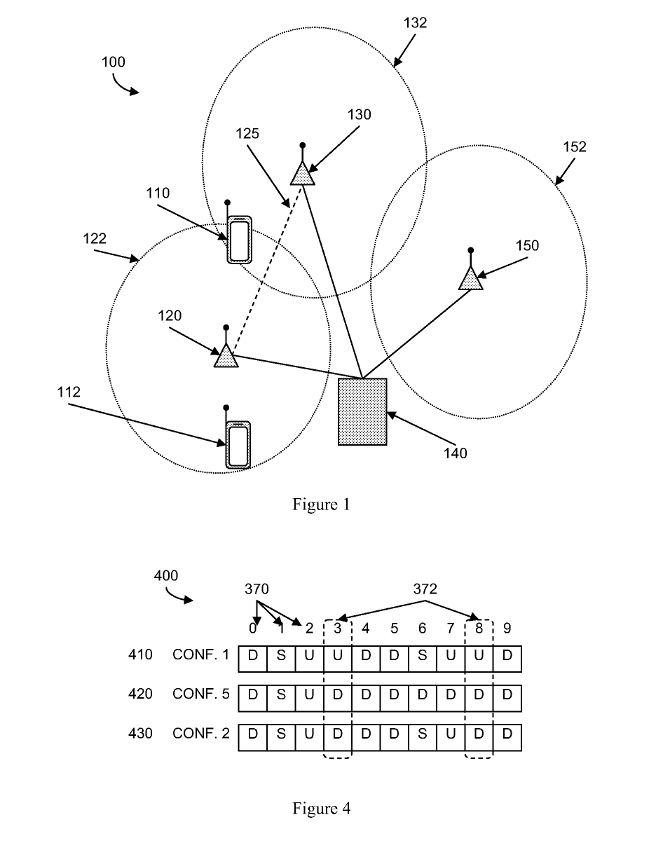

FIG. 1 illustrates an exemplary small cell deployment suitable for use in practicing various exemplary embodiments. The wireless network 100 includes various UEs (110, 112), eNBs (120, 130, 150) and a network control element (140). Each eNB 120, 130, 150 serves an associated cell 122, 132, 152 and may communicate with the network control element 140. Additionally, the eNBs 120, 130, 150 may communicate with each other, for example, eNB 120 may communicate with its neighbor eNB 130 via communication path 125.

Each cell 122, 132, 152 may serve one or more UEs 110, 112. As shown, cell 122, which is served by eNB 120, may be the serving cell for both UE 110 and UE 112.

Cell 132 is shown overlapping cells 122, 152. UE 110 may be considered a cell edge UE due to being in the overlapping area between cell 122 and cell 132. Accordingly, UE 110 may receive signals from both eNB 120 and eNB 130.

In the small cell scenarios (such as those which few UEs and/or small coverage area for example), different TDD configurations could be deployed for each cell in order to provide traffic adaption. For example, cell 122 and cell 132 may be configured with separate TDD configurations.

The TDD configuration for each cell is cell specific and may be decided according to the overall DL/UL traffic load at each individual cell. However for a specific UE, such cell-specific TDD configuration may not be the preferred configuration for its own traffic needs.

For example, if there are N active UEs in a cell and N-1 UEs are UL heavy and only one UE is DL heavy, a TDD configuration with more UL subframes may be configured at the cell level. However, for the DL heavy UE, it would be preferred to have more DL resources in order to fulfill the DL needs.

Furthermore, the traffic between eLA cells may be fluctuating and there may be scenarios where one cell is fully loaded, while its neighbor cell does not have much traffic and there are time-frequency resources being unused. In these situations, cell edge UEs may receive some DL/UL SFs in the serving cell and other DL/UL SFs in the neighbor cell. For example, the DL heavy UE may use DL SFs in the neighbor cell while the serving cell uses those SFs as UL SFs for the other UEs in the cell.

Various exemplary embodiments provide a method, apparatus and computer program(s) to enable neighbor cell assisted TDD configurations.

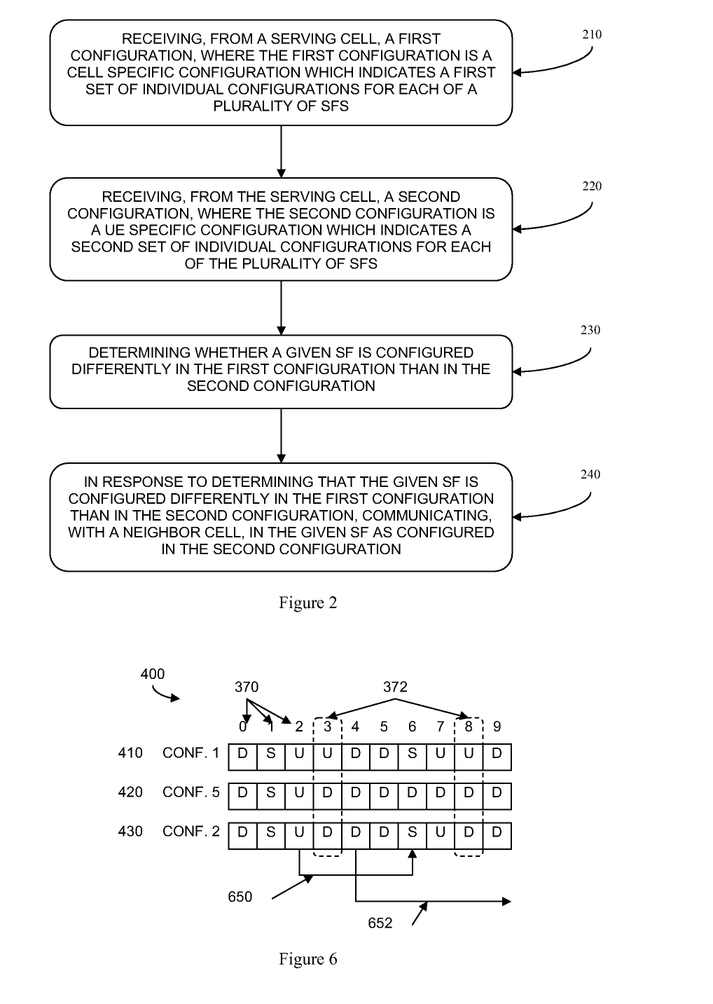

FIG. 2 is a logic flow diagram that illustrates the operation of a method, and a result of execution of computer program instructions, in accordance with exemplary embodiments. In accordance with these exemplary embodiments a method performs, at Block 210, a step of receiving, from a serving cell, a first configuration. The first configuration is a cell specific configuration which indicates a first set of individual configurations for each of a plurality of SFs. At Block 220, the method performs a step of receiving, from the serving cell, a second configuration. The second configuration is a UE specific configuration which indicates a second set of individual configurations for each of the plurality of SFs. The method performs a step of determining whether a given SF is configured differently in the first configuration than in the second configuration at Block 230. In response to determining that the given SF is configured differently in the first configuration than in the second configuration, the method performs, at Block 240, a step of communicating, with a neighbor cell, in the given SF as configured in the second configuration, such as by downloading or uploading data for example.

The neighbor cell assists by providing the cell edge UE packet either DL SFs or UL SFs. The serving eNB configures a cell specific TDD configuration and a separate UE specific TDD configuration for the cell edge UE. The cell edge UE maintains a cell set, which includes its serving cell and a selected neighbor cell. A SF configuration (either DL or UL) for the UE specific configuration may be different from that for cell specific configuration. This is a collision SF (such as where the UE specific configuration for the subframe is DL and the cell specific configuration for the same subframe is UL for example).

If a SF in the cell specific configuration is a UL SF, while in UE specific configuration is DL, UE may look to a neighbor cell (such as listed in the maintained set) in order to detect a neighbor cell PDCCH/ePDCCH to see whether there are DL data packet transmitted from this neighbor cell. Another option is for the UE to detect the PDCCH/ePDCCH from its serving cell by using cross subframe scheduling, to see whether there are DL data packets transmitted from its neighbor cell.

If a SF in the cell specific configuration is configured with a DL, while the UE specific configuration is configured with UL, the UE may transmit a data packet to the neighbor cell according to the received UL grant from the serving cell in the SF while obeying the timing according to the UE specific TDD configuration.

The UE specific configuration may be decided by the serving eNB according to information regarding the cell specific TDD configuration in the serving cell and information regarding the cell specific TDD configuration in the neighbor cell. The serving cell and its neighbor cells coordinate between themselves in order to exchange the information of the individual TDD configuration. The UE specific configuration may then be indicated to the UE, for example, through higher layer signaling or PHY layer signaling.

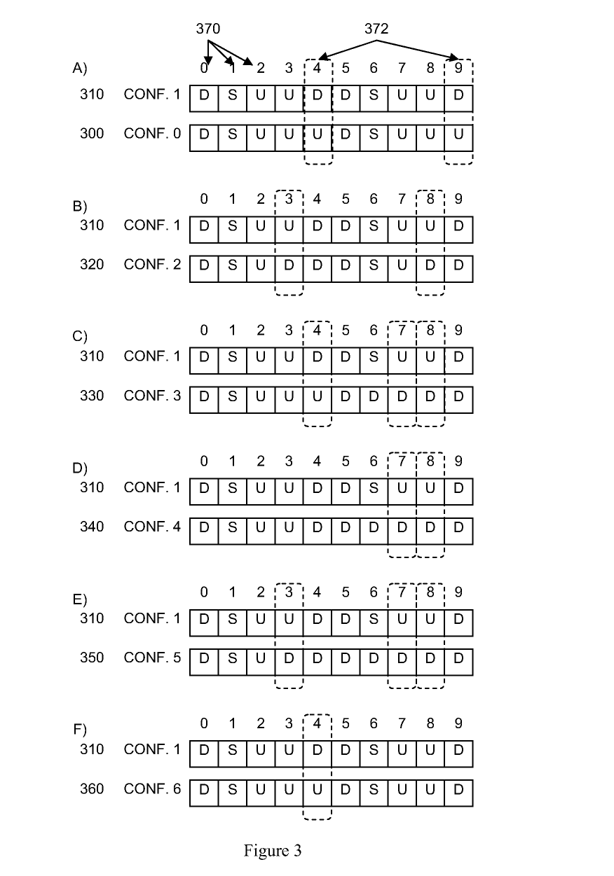

FIG. 3 shows exemplary configurations for use in accordance with various exemplary embodiments. Each pattern (such as configuration 1 (310)) provides a set of individual configurations for each of a plurality of subframes 370. As shown, there are 10 subframes labeled 0-9. Each subframe may be configured as a downlink subframe (D), an uplink subframe (U) or a special subframe (5). In set A), configuration 1 (310) is compared against configuration 0 (300). Subframes 4 and 9 are colliding subframes 372 (indicated by the dash outline) in this set due to the subframes being configured differently. For example, subframe 4 is a downlink subframe in configuration 1 (310) and an uplink subframe in configuration 0 (300). In some embodiments, the special subframe is considered the same as both an uplink subframe and a downlink subframe such that is does not collide with other configurations.

FIG. 3 also shows the comparison of configuration 1 (310) with 5 additional configurations: set B) with configuration 2 (320), set C) with configuration 3 (330), set D) with configuration 4 (340), set E) with configuration 5 (350), set F) with configuration 6 (360).

A specific cell edge UE may be configured with a cell set which include its serving cell and a selected neighbor cell. In a non-limiting example, the serving cell is configured with TDD configuration 1, while the neighbor cell is configured with one of the other six configurations such as those configurations shown in FIG. 3.

Some collision SFs 372 include SFs which are DL SFs in its serving cell, while being a UL SF in the neighbor cell. In such a case, in addition to the cell specific configuration, the UE may be configured with a UE specific TDD configuration with the collision SF being a UL SF. For example, as shown in set A of FIG. 3, where the serving cell uses configuration 1 (310) and the neighbor cell uses configuration 0 (300), a UE may be configured with an additional UE specific configuration 0, borrowing both UL subframes from the neighbor cell, or the UE could be assigned configuration 6 (360) borrowing one UL subframe from the neighbor cell.

Other collision SFs 372 include SFs which are UL SF in the serving cell, while being a DL SF in the neighbor cell. In these cases, the UE may be configured with a UE specific TDD configuration with the collision SF being a DL SF. For example, as shown in set B of FIG. 3, where the serving cell uses configuration 1 (310) and the neighbor cell uses configuration 2 (320), a UE may be configured with a UE specific configuration that borrows two DL subframes from the neighbor cell to assist the UE DL traffic.

The UE specific TDD configurations available for different TDD configuration combinations between serving cell and neighbor cell are listed in Table 1 below. Some configurations allow more DL SF in the UE specific TDD configuration than in the serving cell specific configuration, and vice versa. For example, if the serving cell specific TDD configuration is configuration 1 and the neighbor cell specific TDD configuration is configuration 3, the UE specific TDD configuration may be either configuration 4 (in which case the UE specific TDD configuration has more DL SF) or configuration 6 (in which case the UE specific TDD configuration has more UL SF).

TABLE 1

| UE specific TDD | | Serving Cell specific TDD configuration | | | | | | |
|---|---|---|---|---|---|---|---|---|
| configuration options | | 0 | 1 | 2 | 3 | 4 | 5 | 6 |
| Neighbor cell | 0 | — | 0, 6 | 0, 1, 6 | 0, 6 | 0, 1, 3, 6 | 0, 1, 3, 4 | 0 |
| specific TDD | 1 | 1, 6 | — | 1 | 4 | 1 | 4 | 1 |
| configuration | 2 | 1, 2, 6 | 2 | — | 4, 5 | 5 | 2 | 1, 2 |
| | 3 | 3, 6 | 4, 6 | 5 | — | 3 | 3, 4 | 3 |
| | 4 | 1, 4, 6 | 4 | 5 | 4 | — | 4 | 1, 3, 4 |
| | 5 | 1, 2, 6 | 2, 6 | 5 | 4, 5 | 5 | — | 1, 3, 4, 5 |
| | 6 | 6 | 6 | 1, 6 | 6 | 1, 3 | 1, 6 | — |

The configurations may be signaled with a 2 bit indication (such as through higher layer signaling for example) if the TDD configuration is semi-statically changed or the configurations may be signaled through dynamic indication (such as by using physical layer signaling for example).

FIG. 4 shows a first set of configurations 400 for use by exemplary electronic devices when practicing various exemplary embodiments. In this set up, the serving cell is provided a cell specific configuration 410 that is the same as configuration 1 (310). The neighbor cell 132 has a neighbor cell specific configuration 420 (similar to configuration 5 (350)). The UE 110 is provided a UE specific configuration 430 which is configuration 2 (320).

As shown in set B) of FIG. 3, the colliding subframes 372 of the UE specific configuration 420 are subframes 3 and 8. In this set up, the UE 110 is provided more uplink subframes than the cell specific configuration 410. The UE specific configuration 420 is selected so that the colliding subframes match downlink subframes in the neighbor cell specific configuration 420. Thus, the UE 110 may communicate with the neighbor cell 130 in those subframes.

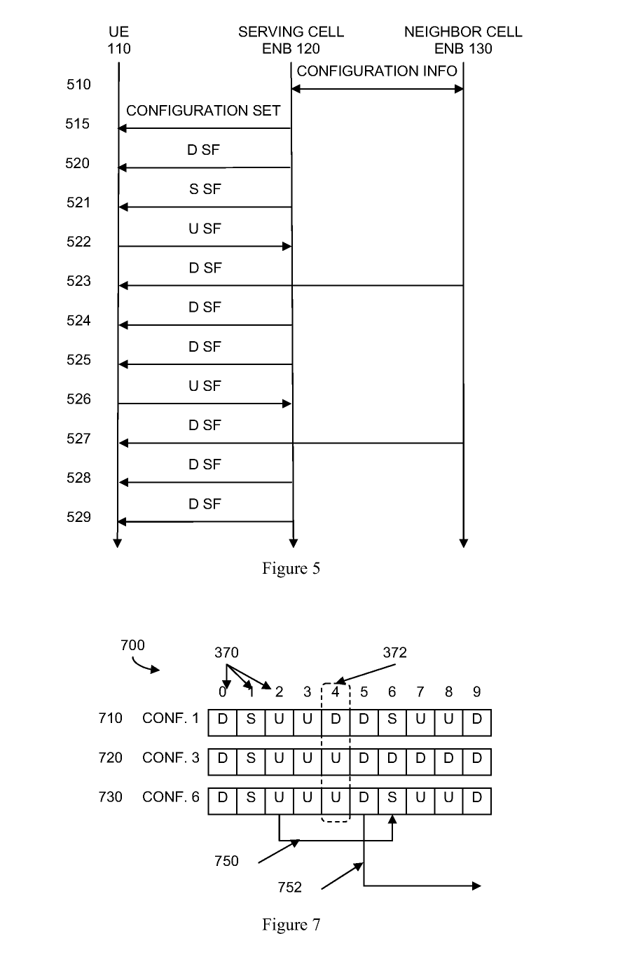

FIG. 5 demonstrates a signaling diagram in accordance with the first set of configurations as shown in FIG. 4. As shown, at time 510, the serving cell eNB 120 communicates with the neighbor cell eNB 130 in order to exchange configuration information. The serving cell eNB 120 uses this configuration information in order to determine an appropriate UE specific configuration 430. The serving cell eNB 120 then provides the UE 110 a) the cell specific configuration 410 for the serving cell 122 and b) the UE specific configuration 430 at time 515.

Times 520-529 each correspond to subframes 0-9. For example, time 520 is a downlink subframe where the serving cell 120 provides downlink data to the UE 110 and time 522 is an uplink subframe where the serving cell 120 receives uplink data from the UE 110.

At time 523, since the cell specific configuration 410 for subframe 3 does not match the UE specific configuration 430 for that subframe, the UE 110 instead obeys the UE 110 specific configuration 430 for the subframe using the neighbor eNB 130. Thus, the UE 110 receives downlink data from the neighbor eNB 130. Likewise, at time 527, the UE 110 again receives downlink data from the neighbor eNB 130.

To achieve the A/N feedback from/to the serving cell, the HARQ timing for the UE configured with both a cell specific configuration and UE specific configuration obeys simple rules. If there are more DL SFs in the UE specific TDD configuration than in the cell specific configuration, the DL HARQ timing obeys the rule for the UE specific TDD configuration, and the UL HARQ timing obeys the rule for the cell specific TDD configuration. On the other hand, if there are more UL SFs in the UE specific TDD configuration than in the cell specific configuration, the DL HARQ timing obeys the rule for the cell specific TDD configuration, and the UL HARQ timing obeys the rule for the UE specific TDD configuration.

To achieve reliable A/N transmissions, the A/N for a DL packet is feedback to the serving eNB, and an A/N for an UL packet is transmitted from the serving eNB.

FIG. 6 shows the first set of configurations 400 for use by exemplary electronic devices when practicing various exemplary embodiments. As discussed in regards to FIG. 4, in this set up, the serving cell uses a cell specific configuration 610, the neighbor cell 132 has a neighbor cell specific configuration 420 and the UE 110 is provided a UE specific configuration 430. FIG. 6 additionally demonstrates UL feedback 650 from the UE regarding SF 2 and DL feedback 652 regarding SF 4.

When preparing the UL/DL feedback 650, 652, the UE compares the number of UL and DL SFs in the cell specific configuration 410 and the UE specific configuration 430. In the first set of configurations 400, the cell specific configuration 410 has 4 DL SFs and 4 UL SFs while the UE specific configuration 430 has 6 DL SFs and 2 UL SFs. Since the number of DL SFs for the UE specific configuration 430 is greater than the number of DL SFs for the cell specific configuration 410, the UE provides the DL feedback 652 in accordance with the UE specific configuration 430 and the UL feedback 650 is received in accordance with the cell specific configuration 410.

The feedback may include acknowledge/negative-acknowledge (A/N) feedback and be provided in accordance with HARQ timing specified by the configuration 410, 430. Additionally, regards of which cell 120, 130 the UE 110 communicates with in a SF 370, the UE 110 may provide the feedback 652 to (or receive the feedback 650 from) the serving cell eNB 120.

In contrast to FIG. 6, FIG. 7 shows a further set of configurations 700 for use by exemplary electronic devices when practicing various exemplary embodiments. In this set up, the serving cell uses a cell specific configuration 710, the neighbor cell 132 has a neighbor cell specific configuration 720 and the UE 110 is provided a UE specific configuration 730. In this set of configurations 700, there are more uplink SFs in the UE specific configuration 730 (5 UL SFs) than in the cell specific configuration 710 (4 UL SFs). Thus, the UE provides the DL feedback 752 in accordance with the cell specific configuration 410 and the UL feedback 750 is received in accordance with the UE specific configuration 430.

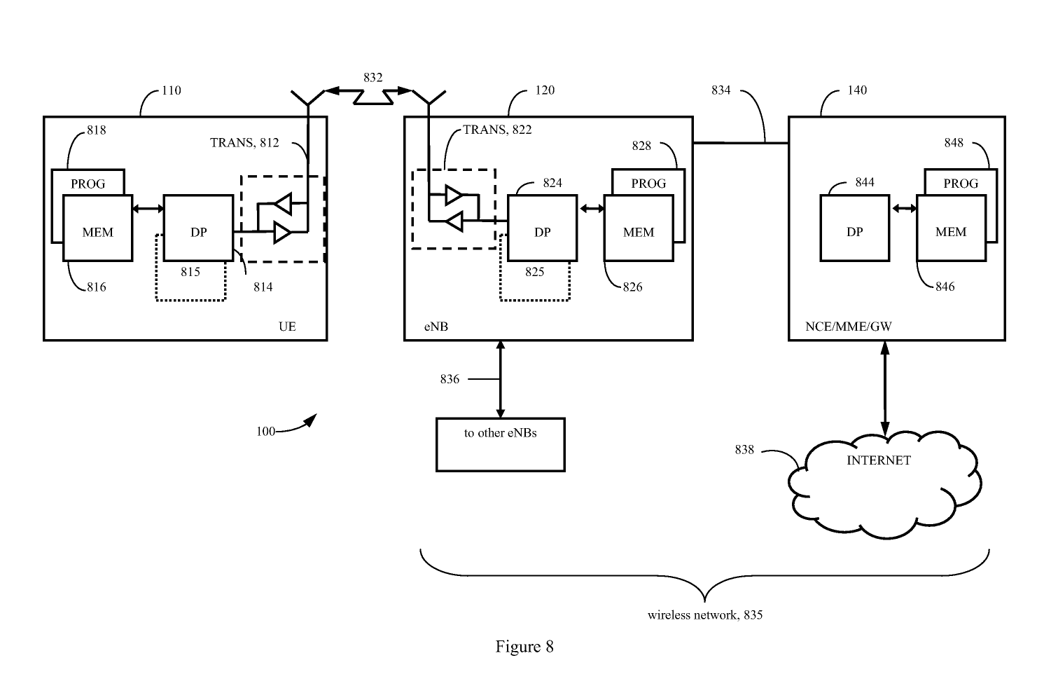

Before describing in further detail various exemplary embodiments, reference is made to FIG. 8 for illustrating a simplified block diagram of various electronic devices and apparatus that are suitable for use in practicing exemplary embodiments.

In the wireless system 100 of FIG. 8, a wireless network 835 is adapted for communication over a wireless link 832 with an apparatus, such as a mobile communication device which may be referred to as a UE 110, via a network access node, such as a Node B (base station), and more specifically an eNB 120. The network 835 may include a network control element (NCE) 140 that may include the MME/SGW functionality and which provides connectivity with a network, such as a telephone network and/or a data communications network (e.g., the internet 838).

The UE 110 includes a controller, such as a computer or a data processor (DP) 814, a computer-readable memory medium embodied as a memory (MEM) 816 that stores a program of computer instructions (PROG) 818, and a suitable wireless interface, such as radio frequency (RF) transceiver 812, for bidirectional wireless communications with the eNB 120 via one or more antennas.

The eNB 120 also includes a controller, such as a computer or a data processor (DP) 824, a computer-readable memory medium embodied as a memory (MEM) 826 that stores a program of computer instructions (PROG) 828, and a suitable wireless interface, such as RF transceiver 822, for communication with the UE 110 via one or more antennas. The eNB 120 is coupled via a data/control path 834 to the NCE 140. The path 834 may be implemented as an S1 interface. The eNB 120 may also be coupled to another eNB via data/control path 836 (or communication path 125), which may be implemented as an X2 interface.

The NCE 140 includes a controller, such as a computer or a data processor (DP) 844, a computer-readable memory medium embodied as a memory (MEM) 846 that stores a program of computer instructions (PROG) 848.

At least one of the PROGs 818, 828 and 848 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 814 of the UE 110; by the DP 824 of the eNB 120; and/or by the DP 844 of the NCE 140, or by hardware, or by a combination of software and hardware (and firmware).

The UE 110 and the eNB 120 may also include dedicated processors, for example subframe scheduling processor 815 and subframe scheduling processor 825.

In general, the various embodiments of the UE 110 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 816, 826 and 846 may be of any type suitable to the local technical environment and may be implemented using any suitable data storage technology, such as semiconductor based memory devices, flash memory, magnetic memory devices and systems, optical memory devices and systems, fixed memory and removable memory. The DPs 814, 824 and 844 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 812 and 822) may be of any type suitable to the local technical environment and may be implemented using any suitable communication technology such as individual transmitters, receivers, transceivers or a combination of such components.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

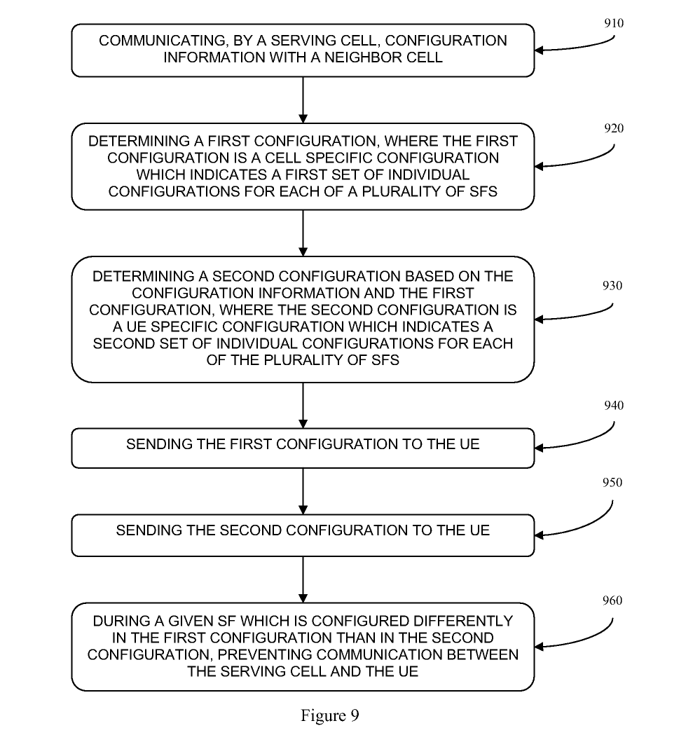

FIG. 9 is a logic flow diagram that illustrates the operation of a method, and a result of execution of computer program instructions, in accordance with exemplary embodiments. In accordance with these exemplary embodiments a method performs, at Block 910, a step of communicating, by a serving cell, configuration information with a neighbor cell, such as by exchanging expected cell specific configurations, etc. for example. At Block 920, the method performs a step of determining a first configuration. The first configuration is a cell specific configuration which indicates a first set of individual configurations for each of a plurality of SFs. Block 920 may be performed prior to Block 910 so that the first configuration may be provided to the neighbor cell.

The method performs, at Block 930, a step of determining a second configuration based on the configuration information and the first configuration. The second configuration is a UE specific configuration which indicates a second set of individual configurations for each of the plurality of SFs. The serving cell eNB 120 uses the communication (performed in Block 910) with the neighbor cell eNB 130 to decide the available UE specific configuration(s). The method also performs, at Block 940, a step of sending the first configuration to the UE and, at Block 950, a step of sending the second configuration to the UE. During a given SF which is configured differently in the first configuration than in the second configuration, the method performs, at Block 960, a step of preventing communication between the serving cell and the UE.

The various blocks shown in FIGS. 2 and 9 may be viewed as method steps, and/or as operations that result from operation of computer program code, and/or as a plurality of coupled logic circuit elements constructed to carry out the associated function(s).

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

An exemplary embodiment provides a method for neighbor cell assisted TDD configurations. The method includes receiving (such as by a TRANS 812 for example), from a serving cell, a first configuration. The first configuration is a cell specific configuration which indicates a first set of individual configurations for each of a plurality of SFs. The method includes receiving (such as by a TRANS 812 for example), from the serving cell, a second configuration. The second configuration is a UE specific configuration which indicates a second set of individual configurations for each of the plurality of SFs. The method includes determining (such as by a DP 814, 815 for example) whether a given SF is configured differently in the first configuration than in the second configuration. In response to determining that the given SF is configured differently in the first configuration than in the second configuration, the method also includes communicating (such as by a TRANS 812 for example), with a neighbor cell, in the given SF as configured in the second configuration.

In a further exemplary embodiment in accordance with the method above, the first configuration is a first TDD configuration and the second configuration is a second TDD configuration.

In another exemplary embodiment in accordance with any one of the methods above, the serving cell is an eLA cell and the UE is a cell edge UE.

In a further exemplary embodiment in accordance with any one of the methods above, the serving cell and the neighbor cell are configured to use the same frequency carrier and bandwidth.

In another exemplary embodiment in accordance with any one of the methods above, the given SF is configured as a DL SF in the second configuration. Communicating, with the neighbor cell, in the given SF includes downloading data from the neighbor cell during the DL SF. The method may also include sending an A/N regarding the data to the serving cell.

In a further exemplary embodiment in accordance with any one of the methods above, the given SF is configured as an UL SF in the second configuration. Communicating, with the neighbor cell, in the given SF includes uploading data to the neighbor cell during the UL SF. The method may also include receiving an A/N regarding the data from the serving cell. Uploading the data may be performed based on an UL grant from the serving cell and a timing provided in the second configuration.

In another exemplary embodiment in accordance with any one of the methods above, the method also includes determining whether the first configuration has more UL SFs than the second configuration; in response to determining that the second configuration has more UL SFs than the first configuration, providing an UL HARQ based on the second configuration and a DL HARQ based on the first configuration; and, in response to determining that the second configuration has more DL SFs than the first configuration, providing a DL HARQ based on the second configuration and an UL HARQ based on the first configuration.

A further exemplary embodiment provides a method for neighbor cell assisted TDD configurations. The method includes communicating (such as by a TRANS 822 for example), by a serving cell, configuration information with a neighbor cell. The method includes determining (such as by DP 824, 825 for example) a first configuration. The first configuration is a cell specific configuration which indicates a first set of individual configurations for each of a plurality of SFs. The method includes determining (such as by a DP 824, 825 for example) a second configuration based on the configuration information and the first configuration. The second configuration is a UE specific configuration which indicates a second set of individual configurations for each of the plurality of SFs. The method includes sending (such as by a TRANS 822 for example) the first configuration to the UE and sending (such as by a TRANS 822 for example) the second configuration to the UE. During a given SF which is configured differently in the first configuration than in the second configuration, the method also includes preventing (such as by a DP 824, 825 for example) communication between the serving cell and the UE.

In another exemplary embodiment in accordance with the method above, the first configuration is a first TDD configuration and the second configuration is a second TDD configuration.

In a further exemplary embodiment in accordance with any one of the methods above, the serving cell is an eLA cell and the UE is a cell edge UE.

In another exemplary embodiment in accordance with any one of the methods above, the serving cell and the neighbor cell are configured to use the same frequency carrier and bandwidth.

In a further exemplary embodiment in accordance with any one of the methods above, the given SF is configured as a DL SF in the second configuration. The method may also include receiving, at the serving cell, an A/N regarding data downloaded by the UE from the neighbor cell during the DL SF.

In another exemplary embodiment in accordance with any one of the methods above, the given SF is configured as an UL SF in the second configuration. The method may include receiving, at the serving cell from the neighbor cell, an A/N regarding data uploaded by the UE to the neighbor cell during the UL SF. The method may also include sending an A/N regarding data uploaded by the UE to the neighbor cell during the UL SF.

Another exemplary embodiment provides an apparatus (such as UE 110 for example) for neighbor cell assisted TDD configurations. The apparatus comprises at least one processor (such as DP 814, 815 for example) and at least one memory (such as MEM 816 for example) storing computer program code (such as PROG 818 for example). The at least one memory and the computer program code are configured to, with the at least one processor, cause the apparatus to perform actions. The actions include to receive, from a serving cell, a first configuration. The first configuration is a cell specific configuration which indicates a first set of individual configurations for each of a plurality of SFs. The actions include to receive, from the serving cell, a second configuration. The second configuration is a UE specific configuration which indicates a second set of individual configurations for each of the plurality of SFs. The actions include to determine whether a given SF is configured differently in the first configuration than in the second configuration. In response to determining that the given SF is configured differently in the first configuration than in the second configuration, the actions also include to communicate, with a neighbor cell, in the given SF as configured in the second configuration.

In a further exemplary embodiment in accordance with the apparatus above, the first configuration is a first TDD configuration and the second configuration is a second TDD configuration.

In another exemplary embodiment in accordance with any one of the apparatus above, the serving cell is an eLA cell and the UE is a cell edge UE.

In a further exemplary embodiment in accordance with any one of the apparatus above, the serving cell and the neighbor cell are configured to use the same frequency carrier and bandwidth.

In another exemplary embodiment in accordance with any one of the apparatus above, the given SF is configured as a DL SF in the second configuration. Communicating, with the neighbor cell, in the given SF includes to download data from the neighbor cell during the DL SF. The actions may also include to send an A/N regarding the data to the serving cell.

In a further exemplary embodiment in accordance with any one of the apparatus above, the given SF is configured as an UL SF in the second configuration. Communicating, with the neighbor cell, in the given SF includes to upload data to the neighbor cell during the UL SF. The actions may also include to receive an A/N regarding the data from the serving cell. Uploading the data may be performed based on an UL grant from the serving cell and a timing provided in the second configuration.

In another exemplary embodiment in accordance with any one of the apparatus above, the actions also include to determine whether the first configuration has more UL SFs than the second configuration; in response to determining that the second configuration has more UL SFs than the first configuration, to provide an UL HARQ based on the second configuration and a DL HARQ based on the first configuration; and, in response to determining that the second configuration has more DL SFs than the first configuration, to provide a DL HARQ based on the second configuration and an UL HARQ based on the first configuration.

In a further exemplary embodiment of any one of the apparatus above, the apparatus is embodied in an integrated circuit.

In another exemplary embodiment of any one of the apparatus above, the apparatus is embodied in a mobile device.

A further exemplary embodiment provides an apparatus (such as eNB 120 for example) for neighbor cell assisted TDD configurations. The apparatus comprises at least one processor (such as DP 824, 825 for example) and at least one memory (such as MEM 826 for example) storing computer program code (such as PROG 818 for example). The at least one memory and the computer program code are configured to, with the at least one processor, cause the apparatus to perform actions. The actions include to communicate, by a serving cell, configuration information with a neighbor cell. The actions include to determine a first configuration. The first configuration is a cell specific configuration which indicates a first set of individual configurations for each of a plurality of SFs. The actions include to determine a second configuration based on the configuration information and the first configuration. The second configuration is a UE specific configuration which indicates a second set of individual configurations for each of the plurality of SFs. The actions include to send the first configuration to the UE and to send the second configuration to the UE. During a given SF which is configured differently in the first configuration than in the second configuration, the actions also include to prevent communication between the serving cell and the UE.

In another exemplary embodiment in accordance with the apparatus above, the first configuration is a first TDD configuration and the second configuration is a second TDD configuration.

In a further exemplary embodiment in accordance with any one of the apparatus above, the serving cell is an eLA cell and the UE is a cell edge UE.

In another exemplary embodiment in accordance with any one of the apparatus above, the serving cell and the neighbor cell are configured to use the same frequency carrier and bandwidth.

In a further exemplary embodiment in accordance with any one of the apparatus above, the given SF is configured as a DL SF in the second configuration. The actions may also include to receive, at the serving cell, an A/N regarding data downloaded by the UE from the neighbor cell during the DL SF.

In another exemplary embodiment in accordance with any one of the apparatus above, the given SF is configured as an UL SF in the second configuration. The actions may include to receive, at the serving cell from the neighbor cell, an A/N regarding data uploaded by the UE to the neighbor cell during the UL SF. The actions may also include to send an A/N regarding data uploaded by the UE to the neighbor cell during the UL SF.

In a further exemplary embodiment of any one of the apparatus above, the apparatus is embodied in an integrated circuit.

In another exemplary embodiment of any one of the apparatus above, the apparatus is embodied in a mobile device.

Another exemplary embodiment provides a computer readable medium (such as MEM 816 for example) for neighbor cell assisted TDD configurations. The computer readable medium is tangibly encoded with a computer program (such as PROG 818 for example) executable by a processor (such as DP 814, 815 for example) to perform actions. The actions include receiving, from a serving cell, a first configuration. The first configuration is a cell specific configuration which indicates a first set of individual configurations for each of a plurality of SFs. The actions include receiving, from the serving cell, a second configuration. The second configuration is a UE specific configuration which indicates a second set of individual configurations for each of the plurality of SFs. The actions include determining whether a given SF is configured differently in the first configuration than in the second configuration. In response to determining that the given SF is configured differently in the first configuration than in the second configuration, the actions also include communicating, with a neighbor cell, in the given SF as configured in the second configuration.

In a further exemplary embodiment in accordance with the computer readable medium above, the first configuration is a first TDD configuration and the second configuration is a second TDD configuration.

In another exemplary embodiment in accordance with any one of the computer readable media above, the serving cell is an eLA cell and the UE is a cell edge UE.

In a further exemplary embodiment in accordance with any one of the computer readable media above, the serving cell and the neighbor cell are configured to use the same frequency carrier and bandwidth.

In another exemplary embodiment in accordance with any one of the computer readable media above, the given SF is configured as a DL SF in the second configuration. Communicating, with the neighbor cell, in the given SF includes downloading data from the neighbor cell during the DL SF. The actions may also include sending an A/N regarding the data to the serving cell.

In a further exemplary embodiment in accordance with any one of the computer readable media above, the given SF is configured as an UL SF in the second configuration. Communicating, with the neighbor cell, in the given SF includes uploading data to the neighbor cell during the UL SF. The actions may also include receiving an A/N regarding the data from the serving cell. Uploading the data may be performed based on an UL grant from the serving cell and a timing provided in the second configuration.

In another exemplary embodiment in accordance with any one of the computer readable media above, the actions also include determining whether the first configuration has more UL SFs than the second configuration; in response to determining that the second configuration has more UL SFs than the first configuration, providing an UL HARQ based on the second configuration and a DL HARQ based on the first configuration; and, in response to determining that the second configuration has more DL SFs than the first configuration, providing a DL HARQ based on the second configuration and an UL HARQ based on the first configuration.

In a further exemplary embodiment of any one of the computer readable media above, the computer readable medium is a storage medium.

In another exemplary embodiment of any one of the computer readable media above, the computer readable medium is a non-transitory computer readable medium (e.g., CD-ROM, RAM, flash memory, etc.).

A further exemplary embodiment provides a computer readable medium (such as MEM 826 for example) for neighbor cell assisted TDD configurations. The computer readable medium is tangibly encoded with a computer program (such as PROG 828 for example) executable by a processor (such as DP 824, 825 for example) to perform actions. The actions include communicating, by a serving cell, configuration information with a neighbor cell. The actions include determining a first configuration. The first configuration is a cell specific configuration which indicates a first set of individual configurations for each of a plurality of SFs. The actions include determining a second configuration based on the configuration information and the first configuration. The second configuration is a UE specific configuration which indicates a second set of individual configurations for each of the plurality of SFs. The actions include sending the first configuration to the UE and sending the second configuration to the UE. The actions also include during a given SF which is configured differently in the first configuration than in the second configuration, preventing communication between the serving cell and the UE.

In another exemplary embodiment in accordance with the computer readable medium above, the first configuration is a first TDD configuration and the second configuration is a second TDD configuration.

In a further exemplary embodiment in accordance with any one of the computer readable media above, the serving cell is an eLA cell and the UE is a cell edge UE.

In another exemplary embodiment in accordance with any one of the computer readable media above, the serving cell and the neighbor cell are configured to use the same frequency carrier and bandwidth.

In a further exemplary embodiment in accordance with any one of the computer readable media above, the given SF is configured as a DL SF in the second configuration. The actions may also include receiving, at the serving cell, an A/N regarding data downloaded by the UE from the neighbor cell during the DL SF.

In another exemplary embodiment in accordance with any one of the computer readable media above, the given SF is configured as an UL SF in the second configuration. The actions may include receiving, at the serving cell from the neighbor cell, an A/N regarding data uploaded by the UE to the neighbor cell during the UL SF. The actions may also include sending an A/N regarding data uploaded by the UE to the neighbor cell during the UL SF.

In a further exemplary embodiment of any one of the computer readable media above, the computer readable medium is a storage medium.

In another exemplary embodiment of any one of the computer readable media above, the computer readable medium is a non-transitory computer readable medium (e.g., CD-ROM, RAM, flash memory, etc.).

Another exemplary embodiment provides an apparatus (such as UE 110 for example) for neighbor cell assisted TDD configurations. The apparatus includes means for receiving (such as DP 814, 815 for example), from a serving cell, a first configuration. The first configuration is a cell specific configuration which indicates a first set of individual configurations for each of a plurality of SFs. The apparatus includes means for receiving (such as TRANS 812 for example), from the serving cell, a second configuration. The second configuration is a UE specific configuration which indicates a second set of individual configurations for each of the plurality of SFs. The apparatus includes means for determining (such as DP 814, 815 for example) whether a given SF is configured differently in the first configuration than in the second configuration. The apparatus also includes means for communicating (such as TRANS 812 for example), with a neighbor cell, in the given SF as configured in the second configuration in response to determining that the given SF is configured differently in the first configuration than in the second configuration.

In a further exemplary embodiment in accordance with the apparatus above, the first configuration is a first TDD configuration and the second configuration is a second TDD configuration.

In another exemplary embodiment in accordance with any one of the apparatus above, the serving cell is an eLA cell and the UE is a cell edge UE.

In a further exemplary embodiment in accordance with any one of the apparatus above, the serving cell and the neighbor cell are configured to use the same frequency carrier and bandwidth.

In another exemplary embodiment in accordance with any one of the apparatus above, the given SF is configured as a DL SF in the second configuration. The communicating means includes means for downloading data from the neighbor cell during the DL SF. The apparatus may also include means for sending an A/N regarding the data to the serving cell.

In a further exemplary embodiment in accordance with any one of the apparatus above, the given SF is configured as an UL SF in the second configuration. The communicating means includes means for uploading data to the neighbor cell during the UL SF. The apparatus may also include means for receiving an A/N regarding the data from the serving cell. Uploading the data may be performed based on an UL grant from the serving cell and a timing provided in the second configuration.

In another exemplary embodiment in accordance with any one of the apparatus above, the apparatus also includes means for determining whether the first configuration has more UL SFs than the second configuration; means for providing an UL HARQ based on the second configuration and a DL HARQ based on the first configuration in response to determining that the second configuration has more UL SFs than the first configuration; and means for providing a DL HARQ based on the second configuration and an UL HARQ based on the first configuration in response to determining that the second configuration has more DL SFs than the first configuration.

A further exemplary embodiment provides an apparatus (such as eNB 120 for example) for neighbor cell assisted TDD configurations. The apparatus includes means for communicating (such as TRANS 822 for example) configuration information with a neighbor cell. The apparatus includes means for determining (such as DP 824, 825 for example) a first configuration. The first configuration is a cell specific configuration which indicates a first set of individual configurations for each of a plurality of SFs. The apparatus includes means for determining (such as DP 824, 825 for example) a second configuration based on the configuration information and the first configuration. The second configuration is a UE specific configuration which indicates a second set of individual configurations for each of the plurality of SFs. The apparatus includes means for sending (such as TRANS 822 for example) the first configuration to the UE and means for sending (such as TRANS 822 for example) the second configuration to the UE. The apparatus also includes means for preventing (such as DP 824, 825 for example) communication between the serving cell and the UE during a given SF which is configured differently in the first configuration than in the second configuration.

In another exemplary embodiment in accordance with the apparatus above, the first configuration is a first TDD configuration and the second configuration is a second TDD configuration.

In a further exemplary embodiment in accordance with any one of the apparatus above, the serving cell is an eLA cell and the UE is a cell edge UE.

In another exemplary embodiment in accordance with any one of the apparatus above, the serving cell and the neighbor cell are configured to use the same frequency carrier and bandwidth.

In a further exemplary embodiment in accordance with any one of the apparatus above, the given SF is configured as a DL SF in the second configuration. The apparatus may also include means for receiving, at the serving cell, an A/N regarding data downloaded by the UE from the neighbor cell during the DL SF.

In another exemplary embodiment in accordance with any one of the apparatus above, the given SF is configured as an UL SF in the second configuration. The apparatus may include means for receiving, at the serving cell from the neighbor cell, an A/N regarding data uploaded by the UE to the neighbor cell during the UL SF. The apparatus may also include means for sending an A/N regarding data uploaded by the UE to the neighbor cell during the UL SF.

For example, while the exemplary embodiments have been described above in the context of the E-UTRAN (UTRAN-LTE) system, it should be appreciated that the exemplary embodiments are not limited for use with only this one particular type of wireless communication system, and that they may be used to advantage in other wireless communication systems such as for example (WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names assigned to different channels (e.g., PDCCH, etc.) are not intended to be limiting in any respect, as these various channels may be identified by any suitable names.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

The following abbreviations that may be found in the specification and/or the drawing figures are defined as follows:

3GPP third generation partnership project

A/N acknowledge/negative-acknowledge

BS basestation

BW bandwidth

CC component carrier

DL downlink (eNB towards UE)

eLA enhanced local area

eNB E-UTRAN Node B (evolved Node B)

E-UTRAN evolved UTRAN (LTE)

HARQ hybrid automatic repeat request

LTE long term evolution of UTRAN (E-UTRAN)

Node B base station

PDCCH physical downlink control channel

PHY physical (layer 1, L1)

SF subframe

TDD time division duplex

TTI transmission time interval

UE user equipment, such as a mobile station or mobile terminal

UL uplink (UE towards eNB)

UTRAN universal terrestrial radio access network

1-31. (canceled)

32. An apparatus, comprising at least one processor; and at least one memory including computer program code, the at least one memory and the computer program code configured to, with the at least one processor, cause the apparatus to perform at least the following:
to receive, from a serving cell, a first configuration, where the first configuration is a cell specific configuration which indicates a first set of individual configurations for each of a plurality of subframes;
to receive, from the serving cell, a second configuration, where the second configuration is a user equipment specific configuration which indicates a second set of individual configurations for each of the plurality of subframes;
to determine whether a given subframe is configured differently in the first configuration than in the second configuration; and
in response to determine that the given subframe is configured differently in the first configuration than in the second configuration, to communicate, with a neighbor cell, in the given subframe as configured in the second configuration.

33. The apparatus of claim 32, where the first configuration is a first time domain duplex configuration and the second configuration is a second time domain duplex configuration.

34. The apparatus of claim 32, where communicating with a neighbor cell comprises determining whether a downlink data packet is transmitted in a subframe from the neighbor cell based on a detected downlink control channel from one of: the neighbor cell in the subframe and the serving cell in a previous subframe.

35. The apparatus of claim 32, where the serving cell and the neighbor cell are configured to use the same frequency carrier and bandwidth.

36. The apparatus of claim 32, where the given subframe is configured as a downlink subframe in the second configuration and
where communicating, with the neighbor cell, in the given subframe comprises downloading data from the neighbor cell during the downlink subframe.

37. The apparatus of claim 36, where the at least one memory and the computer program code are further configured to cause the apparatus to send an acknowledgement/negative-acknowledgement regarding the data to the serving cell.

38. The apparatus of claim 32, where the given subframe is configured as an uplink subframe in the second configuration and
where communicating, with the neighbor cell, in the given subframe comprises uploading data to the neighbor cell during the uplink subframe.

39. The apparatus of claim 38, where the at least one memory and the computer program code are further configured to cause the apparatus to receive an acknowledgement/negative-acknowledgement regarding the data from the serving cell.

40. The apparatus of claim 38, where uploading the data is performed based on an uplink grant from the serving cell and a timing provided in the second configuration.

41. The apparatus of claim 32, where the at least one memory and the computer program code are further configured to cause the apparatus:
to determine whether the first configuration has more uplink subframes than the second configuration;
in response to determine that the second configuration has more uplink subframes than the first configuration, to provide an uplink hybrid automatic repeat request timing based on the second configuration and a downlink hybrid automatic repeat request timing based on the first configuration; and
in response to determine that the second configuration has more downlink subframes than the first configuration, to provide a downlink hybrid automatic repeat request timing based on the second configuration and an uplink hybrid automatic repeat request timing based on the first configuration.

42. An apparatus, comprising at least one processor; and at least one memory including computer program code, the at least one memory and the computer program code configured to, with the at least one processor, cause the apparatus to perform at least the following:
to communicate, by a serving cell, configuration information with a neighbor cell;
to determine a first configuration, where the first configuration is a cell specific configuration which indicates a first set of individual configurations for each of a plurality of subframes;
to determine a second configuration based on the configuration information and the first configuration, where the second configuration is a user equipment specific configuration which indicates a second set of individual configurations for each of the plurality of subframes;
to send the first configuration to the user equipment;
to send the second configuration to the user equipment; and
during a given subframe which is configured differently in the first configuration than in the second configuration, to prevent communication between the serving cell and the user equipment.

43. The apparatus of claim 42, where the first configuration is a first time domain duplex configuration and the second configuration is a second time domain duplex configuration.

44. The apparatus of claim 42, where communicating with a neighbor cell comprises determining whether a downlink data packet is transmitted in a subframe from the neighbor cell based on a detected downlink control channel from one of: the neighbor cell in the subframe and the serving cell in a previous subframe.

45. The apparatus of claim 42, where the serving cell and the neighbor cell are configured to use the same frequency carrier and bandwidth.

46. The apparatus of claim 42, where the given subframe is configured as a downlink subframe in the second configuration.

47. The apparatus of claim 46, where the at least one memory and the computer program code are further configured to cause the apparatus to receive, at the serving cell, an acknowledgement/negative-acknowledgement regarding data downloaded by the user equipment from the neighbor cell during the downlink subframe.

48. The apparatus of claim 42, where the given subframe is configured as an uplink subframe in the second configuration.

49. The apparatus of claim 48, where the at least one memory and the computer program code are further configured to cause the apparatus to receive, at the serving cell from the neighbor cell, an acknowledgement/negative-acknowledgement regarding data uploaded by the user equipment to the neighbor cell during the uplink subframe.

50. The apparatus of claim 48, where the at least one memory and the computer program code are further configured to cause the apparatus to send an acknowledgement/negative-acknowledgement regarding data uploaded by the user equipment to the neighbor cell during the uplink subframe.

51. A method comprising:
receiving, from a serving cell, a first configuration, where the first configuration is a cell specific configuration which indicates a first set of individual configurations for each of a plurality of subframes;
receiving, from the serving cell, a second configuration, where the second configuration is a user equipment specific configuration which indicates a second set of individual configurations for each of the plurality of subframes;
determining whether a given subframe is configured differently in the first configuration than in the second configuration; and
in response to determining that the given subframe is configured differently in the first configuration than in the second configuration, communicating, with a neighbor cell, in the given subframe as configured in the second configuration.
